(19) United States
(12) Patent Application Publication
(10) Pub. No.: US 2009/0313381 A1
(43) Pub. Date: Dec. 17, 2009

(54) MEDIA DATA TRANSMISSION SYSTEM AND METHOD

(75) Inventor: Chun Kai Chan, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTek Computer Inc., Taipei City (TW)

(21) Appl. No.: 12/425,427

(22) Filed: Apr. 17, 2009

(30) Foreign Application Priority Data
Jun. 12, 2008 (TW) 97121862

(51) Int. Cl. G06F 15/16

(52) U.S. Cl. 709/231

(57) ABSTRACT

A media data transmission system is provided. The system includes a media player and a computer. The media player includes a playing unit, a first connector and a file format transformation program. The computer includes a random access memory, a second connector, a second storage unit for storing media with a first format and a processor. The processor copies and transmits the file format transformation program to the random access memory, and transforms the format of the media data to a second format via the format transformation program.

### CROSS REFERENCE TO RELATED APPLICATIONS

This Application claims priority of Taiwan Patent Application No. 97121862, filed on Jun. 12, 2008, the entirety of which is incorporated by reference herein.

### BACKGROUND OF THE INVENTION

1. Field of the Invention

The invention relates to a media data transmission system, and more particularly to a media data transmission system between a computer host and an audio data storage device with increased audio data storage capacity.

2. Description of the Related Art

Recently, MP3 (MPEG Audio Layer-3) music files are being more commonly transmitted over the internet due to increased internet usage. Generally, MP3 files are stored to MP3 players by a computer host, such as personal computer. However, formats supported by media players are media player specific. Thus, user must transform audio file formats into a specific format via a computer, before storing the transformed audio data to the media player for operation. Or, user must use a specific transmission program to transmit the audio data to the media player. But, if the computer host does not have a corresponding format transformation program or file transmission program, users cannot store the audio file to the media player.

### BRIEF SUMMARY OF THE INVENTION

An embodiment of invention provides a media data transmission system. The system includes a media player and a computer. The media player includes a playing unit, a first connector and a file format transformation program. The computer includes a random access memory, a second connector, a second storage unit for storing media with a first format and a processor. The processor copies and transmits the file format transformation program to the random access memory, and transforms the format of the media data to a second format via the format transformation program.

Another embodiment of the invention provides a media data transmission method between a computer and a media player. The method comprises: detecting whether media data of a first format has been transmitted from the computer to the media player; acquiring a file format transformation program via the computer from the media player according to a control signal; the computer transforming the first format of the media data into a second format via the file format transformation program; transmitting the media data of the second format to the media player for operation.

Anther embodiment of the invention provides a method for storing a media data for a media player. The method comprises: receiving media data from a first connector of the media player; detecting the format of the received media data, wherein the format of the media data is a first format; determining whether the first format is a specific format of a configuration file; when the first format matches the specific format of the configuration file, accessing a file format transformation program corresponding to the first format; transforming the format of the media data from the first format into a second format via the file format transformation program; storing the media data with the second format.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flowchart of an embodiment of a media data transmission method according to the invention.

FIG. 2 is a functional block diagram of an embodiment of a media data transmission system according to the invention.

FIG. 3 is a flowchart of an embodiment of a media data storage method according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

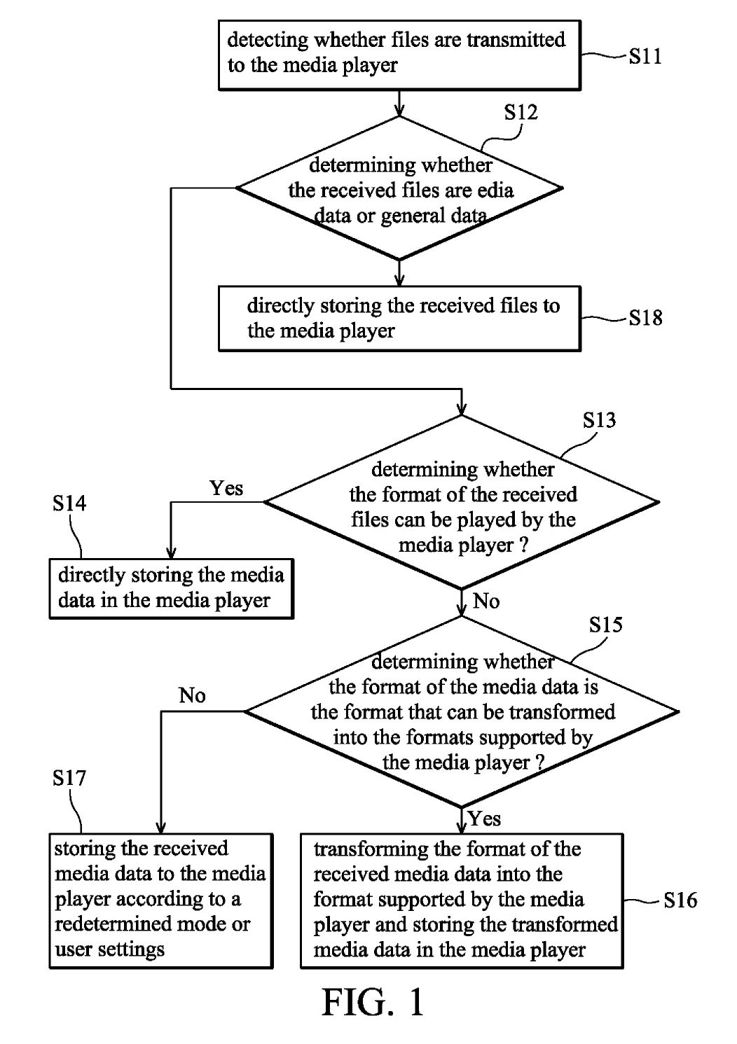

FIG. 1 is a flowchart of an embodiment of a media data transmission method according to the invention. In step S11, a media player detects whether the computer host, such as a personal computer, has transmitted files to the media player. If yes, the procedure goes to step S12. If not, the procedure stays at step S11, and the media player continues detecting whether the computer host has transmitted files to the media player. In step S12, the received files are determined to be media data or general data. If the received files are media data, the procedure goes to step S13. If the received files are general data, the procedure goes to step S18. In this embodiment, general data means document data, compressed data or data which cannot be played by media player. In step S18, the received files are directly stored in the media player. In step S13, the media player determines whether the format of the received files can be played by the media player. If yes, the procedure goes to step S14, and the media data is directly stored in the media player. If the format of the media data is not supported by the media player, the procedure goes to step S15 to determine whether the format of the media data is the format that can be transformed into the formats supported by the media player. In this embodiment, defining which formats can and can not be transformed into the formats support by the media player by a file format transformation program can be preset. In step S15, if the format of the media data can be transformed via the file format transformation program, the procedure goes to step S16, and the media data is transformed into the media data supported by the media player and then the transformed media data is then stored in the media player.

In this embodiment, the file format transformation program is stored in the media player. When the media player is connected to the computer, the media player transmits the file format transformation program to the computer by a built-in firmware, and the firmware is then stored in the random access memory (RAM) of the computer. When the format of the media data has to be transformed, the processor of the computer executes the file format transformation program residing in the RAM. If the media player is connected to the computer via a USB port, the file format transformation program can be contained in the USB firmware of the media player. When the media player connects to the computer, the media player communicates with the computer via the USB firmware and transmits and stores the file format transformation program in the RAM of the computer. In another embodiment, a file, autorun.inf, is built into the media player and the file format transformation program is stored in the media player. When the computer connects to the media player, the operating system of the computer first searches the file, autorun.inf, and loads the file format transformation program according to the file, autorun.inf. When the format of the received media data has to be transformed, the processor of the computer executes the file format transformation program to transform the format of the received media data into the format supported by the media player.

In the step S17, if the format of the media data cannot be transformed via the file format transformation program, the media data is determined to be stored in the media player or not according to user settings. If the media data is stored to the media player according to user settings, the processor built into the media player records the format of the media data in a configuration file, and when the media player detects the data of the format of the media data in a configuration file, the media player directly stores the media data to the media player. In the embodiment, a user can use a button, a touch screen or any similar input device of the media player to input an external control signal to determine whether the format of the received media data has to be transformed into the format supported by the media player. Furthermore, the media player comprises a configuration file to record a user's use mode, format of the received data and corresponding control mechanisms. When the processor of the media player detects that the format of the media is not supported by the media player, the processor reads the configuration file and outputs a control signal to determine whether the format of the media data has to be transformed.

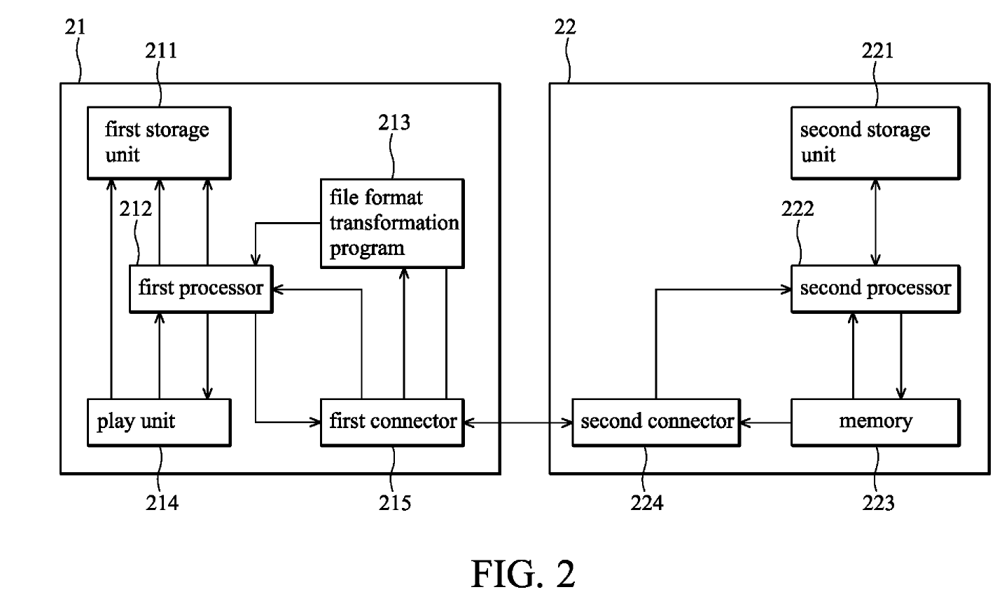

FIG. 2 is a functional block diagram of an embodiment of a media data transmission system according to the invention. This embodiment illustrates media data transmission between the computer and media player. Typically, audio file formats supported by media players are wav, mp3 or other similar formats. But some kinds of media players have to transform audio data format into a specific format for operation. In one example, file format transformation is implemented by an application program of the computer. However, this is not convenient for users. Therefore, the embodiment provides a media data transmission system, wherein users can directly copy and store the media data to the media player via the file format transformation program built into the media player.

The media player 21 comprises a first storage unit 211, a first processor 212, a file format transformation program 213, a play unit 214 and a first connector 215. The computer 22 comprises a second storage unit 221, a second processor 222, a memory 223 and a second connector 224. When the media player 21 connects to the second connector 224 of the computer 22 via the first connector 215, the media player 21 detects whether the computer 22 connected to the media player 21 and the computer 22 has data to transmit to the computer 22 via a firmware. When the computer 22 transmits media data to the media player 21, the first processor 212 determines whether the format of the media data can be played via the media player 21. If yes, the media data is directly transmitted and stored in the first storage unit 211. In another embodiment, the format of the media data is a first format and when the first processor 212 detects that the format of the media data is a first format, the first processor 212 searches a configuration file and determines whether the first format is a specific input file transformation format. If yes, the first processor 212 calls the file format transformation program 213, transforms the format of the media data from the first format into the second format according to file format transformation program 213 and stores the transformed media data in the first storage unit 211. In another embodiment, the file format transformation program 21 is stored in RAM of read only memory (ROM).

In another embodiment, when detecting that the format of the media data cannot be supported by the play unit 213, a response signal is transmitted to the second processor 222. The second processor copies and stores the file format transformation program in the memory 223 according to the response signal. When the media data in the second storage unit 221 is transmitted to the media player 21, the second processor 222 transforms the format of the media data into a second format that can be played by the play unit 214 via the file format transformation program. Then, the first processor 212 stores the transformed data into the first storage 211.

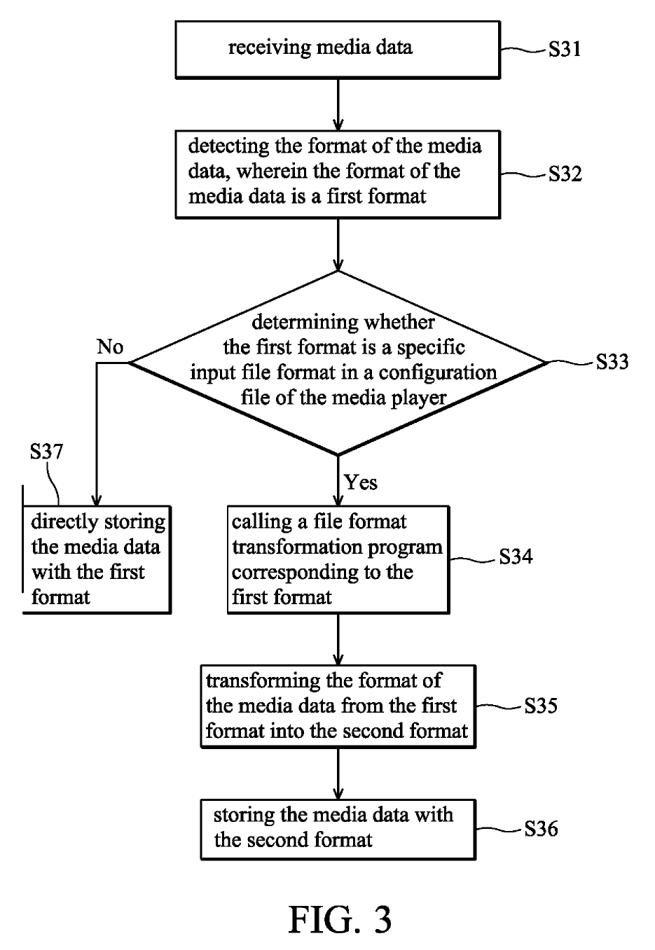

FIG. 3 is a flowchart of an embodiment of a media data storage method according to the invention. In this embodiment, the media data storage method is for a media player. When the media player receives media data (step S31), the media player detects the format of the media data, wherein the format of the media data is a first format (step S32). In one embodiment, the steps S31 and S32 can be implemented by firmware of the media player. In step S33, the media player determines whether the first format is a specific input file format in a configuration file of the media player. If yes, the procedure goes to step S34. If not, the procedure goes to step S37, and the media player directly stores the media data with the first format. In step S34, a processor of the media player access a file format transformation program. In step S35, the media player transforms the format of the media data from the first format into the second format. In the step S36, the media player stores and plays the media data with the second format.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A media data transmission system, comprising:
a media player, comprising:
a playing unit;
a first connector; and
a file format transformation program; and
a computer, comprising:
a random access memory;
a second connector;
a second storage unit to store media with a first format; and
a processor to copy and transmit the file format transformation program to the random access memory, and transform the first format of the media data into a second format by the format transformation program.

2. The system as claimed in claim 1, wherein when the media data is transmitted to the media player, the processor determines whether the first format of the media data is transformed into the second format according to a control signal.

3. The system as claimed in claim 2, wherein the control signal is determined according to an external signal received via the media player.

4. The system as claimed in claim 3, wherein the external signal is input via a button, touch screen or an input device.

5. The system as claimed in claim 2, wherein the control signal is determined based on a configuration file.

6. The system as claimed in claim 5, wherein if the configuration file does not contain the control signal, the control signal is determined according to an external signal received via the media player.

7. The system as claimed in claim 5, wherein the media player further comprises a first storage unit to store the media data.

8. The system as claimed in claim 1, wherein the media player further comprises a second processor, and when the second processor detects that the media data is transmitted to the media player, the second processor determine whether the first format of the media data is formatted, and if not, the second processor outputs a control signal to the processor and the processor copies the file format transformation program to the random access memory.

9. The system as claimed in claim 1, wherein the media player further comprises a configuration file storing a plurality of formats, and when the first format of the media data does not belong to the plurality of formats in the configuration file, the processor copies the file format transformation program to the random access memory to transform the first format of the media data.

10. The system as claimed in claim 1, further comprising a first firmware to detect whether the first connector is connected to the second connector.

11. A media data transmission method between a computer and a media player, comprising:
detecting whether media data of a first format has been transmitted from the computer to the media player;
acquiring a file format transformation program via the computer from the media player according to a control signal;
the computer transforming the first format of the media data into a second format via the file format transformation program; and
transmitting the media data of the second format to the media player for operation.

12. The method as claimed in claim 11, further comprising:
providing a configuration file, and when detecting that the media data has been transmitted to the media player, determining whether the first format of the media data has to be transformed according to the configuration file.

13. The method as claimed in claim 12, wherein when the first format of the media data does not have to be transformed, the media data is directly stored in the media player with the first format.

14. The method as claimed in claim 12, wherein the control signal is determined according to the configuration file.

15. The method as claimed in claim 11, further comprising:
determining whether the computer has to acquire the file format transformation program from the media player and transform the first format of the media data into the second format according to an external signal received via the media player.

16. The method as claimed in claim 15, wherein the external signal is input by a button, touch screen or an input device of the media player.

17. The method as claimed in claim 11, further comprising:
detecting whether the first format of the media data can be played via the media player; and
when the first format of the media data cannot be player via the media player, the computer acquires the file format transformation program from the media player.

18. The method as claimed in claim 11, further comprising:
continual real time detection of each data transmitted to the media player, and determining whether the first format of the data has to be transformed into the second format according to the first format of the data.

19. A method for storing a media data for a media player, comprising:
receiving media data from a first connector of the media player;
detecting the format of the received media data, wherein the format of the media data is a first format;
determining whether the first format is a specific format of a configuration file;
when the first format matches the specific format of the configuration file, accessing a file format transformation program corresponding to the first format;
transforming the format of the media data from the first format into a second format via the file format transformation program; and
storing the media data with the second format.

20. The method as claimed in claim 19, further comprising:
when the first format does not match the specific format in the configuration file, directly storing the media data of the first format to the media player.
